(19) United States
(12) Patent Application Publication
(10) Pub. No.: US 2026/0157258 A1
(43) Pub. Date: Jun. 11, 2026

(54) SYSTEMS, METHODS AND NON-TRANSITORY COMPUTER-READABLE MEDIA FOR VESTIGIAL PATH REMOVAL

(71) Applicant: Deere & Company, Moline, IL (US)

(72) Inventors: Amey G. KATTI, Pune (IN); Manu PODUVAL, Pune (IN)

(73) Assignee: Deere & Company, Moline, IL (US)

(21) Appl. No.: 18/973,462

(22) Filed: Dec. 9, 2024

(51) Int. Cl. A01B 69/04; B62D 15/02; G01C 21/34

(52) U.S. Cl. CPC A01B 69/008; B62D 15/025; G01C 21/3446

(57) ABSTRACT

Systems, methods, and non-transitory computer-readable media for generating a navigational path. A system on a vehicle includes processing circuitry configured to cause the system to determine whether a first coordinate point is a vestigial coordinate point, the first coordinate point being among a plurality of coordinate points, each coordinate point among the plurality of coordinate points representing a corresponding geographical position of the vehicle, generate a plurality of non-vestigial coordinate points based on the plurality of coordinate points in response to determining the first coordinate point is the vestigial coordinate point, the first coordinate point not being included among the plurality of non-vestigial coordinate points, and generate a first navigational path based on the plurality of non-vestigial coordinate points.

### FIELD OF THE DISCLOSURE

Some example embodiments provide systems, methods and non-transitory computer-readable media for removing vestigial navigation paths.

### BACKGROUND

In agricultural and/or industrial applications, vehicles collect geographical coordinate points while traveling in an operational area for use in generating navigational paths. In subsequent operations, the vehicles navigate the operational area by following the generated navigational paths.

### SUMMARY

Some example embodiments provide improved systems, methods and non-transitory computer-readable media that remove vestigial navigational paths.

Some example embodiments provide a system on a vehicle, the system including processing circuitry configured to cause the system to determine whether a first coordinate point is a vestigial coordinate point, the first coordinate point being among a plurality of coordinate points, each coordinate point among the plurality of coordinate points representing a corresponding geographical position of the vehicle, generate a plurality of non-vestigial coordinate points based on the plurality of coordinate points in response to determining the first coordinate point is the vestigial coordinate point, the first coordinate point not being included among the plurality of non-vestigial coordinate points, and generate a first navigational path based on the plurality of non-vestigial coordinate points.

Some example embodiments provide a method including determining whether a first coordinate point is a vestigial coordinate point, the first coordinate point being among a plurality of coordinate points, each coordinate point among the plurality of coordinate points representing a corresponding geographical position of a vehicle, generating a plurality of non-vestigial coordinate points based on the plurality of coordinate points in response to determining the first coordinate point is the vestigial coordinate point, the first coordinate point not being included among the plurality of non-vestigial coordinate points, and generating a first navigational path based on the plurality of non-vestigial coordinate points.

Some example embodiments provide a non-transitory computer-readable medium storing instructions that, when executed by at least one processor, cause the at least one processor to perform a method, the method including determining whether a first coordinate point is a vestigial coordinate point, the first coordinate point being among a plurality of coordinate points, each coordinate point among the plurality of coordinate points representing a corresponding geographical position of a vehicle, generating a plurality of non-vestigial coordinate points based on the plurality of coordinate points in response to determining the first coordinate point is the vestigial coordinate point, the first coordinate point not being included among the plurality of non-vestigial coordinate points, and generating a first navigational path based on the plurality of non-vestigial coordinate points.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For the purposes of clarity, various dimensions of the drawings may have been exaggerated.

FIG. 1 illustrates a vehicle, in accordance with some example embodiments;

FIG. 2 illustrates a system for controlling a vehicle, according to some example embodiments;

FIGS. 3A-3D illustrate conditions in which vestigial coordinate points and paths are generated, according to some example embodiments; and

FIG. 4 illustrates a method for obtaining non-vestigial coordinate points and paths, according to some example embodiments.

### DETAILED DESCRIPTION

While performing an operation (e.g., an agricultural and/or industrial operation) in an operational area (e.g., a field), a vehicle may record (e.g., periodically record) geographical coordinate points representative of a current position of the vehicle. For example, the vehicle may obtain the geographical coordinate points from a satellite navigation system (e.g., a Global Positioning System (GPS) receiver) on the vehicle. The obtained coordinate points may be used to generate a navigational path to be followed in a subsequent operation in the operational area. According to some example embodiments, the geographical coordinate points may include current x and y coordinates (e.g., Easting and Northing, respectfully), but some example embodiments are not limited thereto.

However, some of the navigational paths and/or geographical coordinate points may not be useful for navigation in the subsequent operation. For example, coordinate points collected while the vehicle is performing a maneuver not related to the operation (e.g., reversing, traveling between different operational areas, etc.), and/or paths generated based on such coordinate points, may not be useful for navigating the operational area (such coordinate points and/or paths may be referred to as vestigial coordinate points and/or paths herein). In existing devices and methods, these vestigial coordinate points and/or navigational paths function as noise that frustrates attempts to generate useful navigational paths to be followed in subsequent operations. For example, in the existing devices and methods, such vestigial paths/points result in the generation of inaccurate navigational paths that are difficult for vehicles to follow, and result in excessive resource consumption (e.g., delay, vehicle fuel, vehicle wear, etc.) due to maneuvering performed to correct for the inaccurate paths, and/or property damage (e.g., to a crop, the vehicle, other objects in the operational area, etc.) caused by the vehicle following the inaccurate paths.

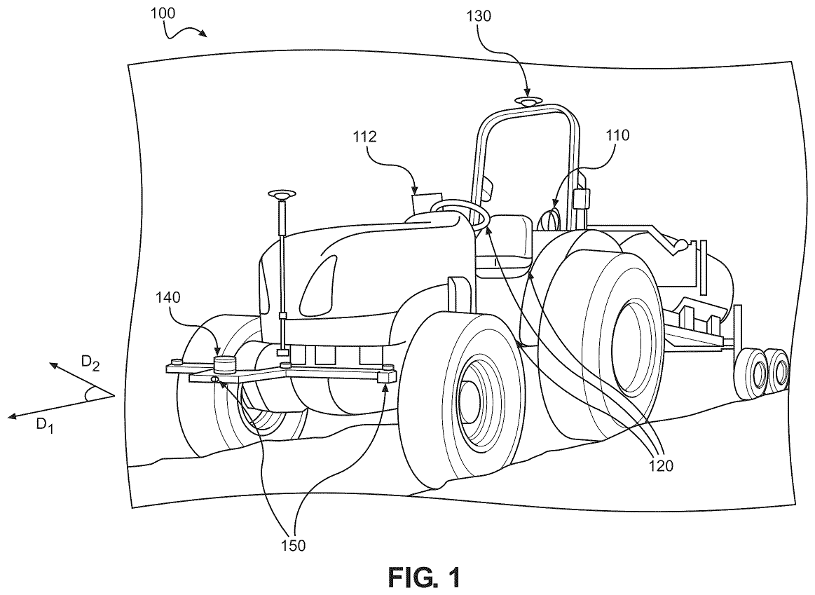

FIG. 1 illustrates a vehicle, in accordance with some example embodiments.

Referring to FIG. 1, depicted is a side view of a vehicle 100. In FIG. 1, the vehicle is illustrated as being a tractor with a sprayer attached to the rear of the tractor, however some example embodiments are not limited thereto. According to some example embodiments, the vehicle 100 may be a harvester (e.g., a combine harvester, etc.), a self-propelled sprayer, a windrower, a tractor (with or without a front or rear implement attached), or any other vehicle. For example, the vehicle 100 may be any vehicle for use in performing agricultural or industrial operations (e.g., tilling, seeding, planting, spraying, harvesting, cutting, mowing, shredding, ripping, etc.). The vehicle 100 may include a processing apparatus 110, an on-board user interface 112 (e.g., including a touchscreen), steering, pedal and implement actuators 120 (e.g., a steering actuator(s), a pedal actuator(s) and/or an implement actuator(s)) configured to control the vehicle 100 (and/or any implements attached thereto) via a manual control interface of the tractor, a global positioning system (GPS) receiver 130 mounted on the cab of the vehicle 100, one or more perception sensors 140, and/or e-stops 150 configured to shut down the vehicle 100 when they are pressed or activated (collectively referred to herein as the components of the vehicle 100). However, some example embodiments are not limited to, and the vehicle 100 may include additional and/or fewer components relative to those mentioned above. According to some example embodiments, the vehicle 100 may be autonomous (e.g., fully autonomous or partially autonomous), but some example embodiments are not limited thereto and the vehicle 100 may be controlled (e.g., at least partially controlled) by an operator. One or more implements may be attached (e.g., removably attached) to the vehicle 100. For example, types of the implements may include tillers, seeders, planters, sprayers, harvesting blades, cutters, mowers, shredders, rippers, various types of harvester headers (e.g., for harvesting corresponding types of crops such as sugar, cotton, etc.), or any other implements (e.g., any other implements for performing an agricultural or industrial operation). Implements may be removably attached to a tractor or any other vehicle 100 (e.g., the harvester, the self-propelled sprayer, the windrower, etc.). According to some example embodiments, each of the types implements may also be implemented as a corresponding self-propelled vehicle 100 (e.g., a tiller vehicle, a seeder vehicle, a planter vehicle, a sprayer vehicle, a harvester vehicle, a cutter vehicle, a mower vehicle, a shredder vehicle, a ripper vehicle, etc.).

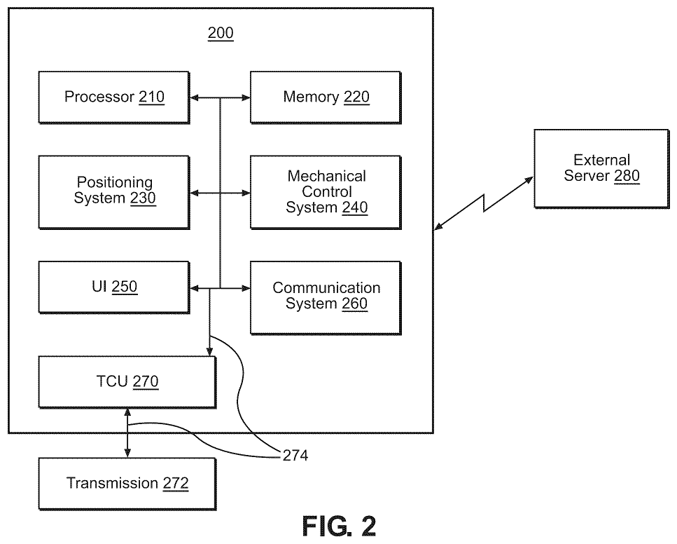

FIG. 2 illustrates a system for controlling a vehicle, according to some example embodiments.

Referring to FIG. 2, a system 200 may include a processor 210, a memory 220, a positioning system 230, a mechanical control system 240, a user interface (UI) 250, a communication system 260 and/or a transmission control unit (TCU) 270 (collectively referred to herein as the components of the system 200). According to some example embodiments, the system 200 may be included on the vehicle 100 but some example embodiments are not limited thereto. According to some example embodiments, the system 200 may include more or fewer components than those discussed above.

The processor 210 (e.g., the processing apparatus 110) may control overall operation of the system 200 and may be implemented using processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

The processor 210 may store and/or retrieve data to and/or from the memory 220 (e.g., programming instructions for execution by the processor 210, operational data generated by the processor 210, etc.). The processor 210 may communicate with, and/or control, the positioning system 230, the mechanical control system 240, the UI 250 and/or the communication system 260.

The memory 220 may be a tangible, non-transitory computer-readable medium, such as a Random Access Memory (RAM), a flash memory, a Read Only Memory (ROM), an Electrically Programmable ROM (EPROM), an Electrically Erasable Programmable ROM (EEPROM), registers, a hard disk, a removable disk, a Compact Disk (CD) ROM, any combination thereof, or any other form of storage medium known in the art. The memory 220 may store data and/or instructions for retrieval by, for example, the processor 210.

The positioning system 230 may receive one or more signals representative of a current position of the vehicle 100 and/or information from which the current position of the vehicle 100 may be calculated (e.g., by the positioning system 230 and/or the processor 210). According to some example embodiments, the positioning system 230 may include a receiver capable of receiving signals from a satellite navigation system (e.g., a Global Navigation Satellite System (GNSS)) such as, for example, the Global Positioning System (GPS), the Global Navigation Satellite System (GLONASS), the BeiDou Navigation Satellite System (BDS), etc. For example, the positioning system 230 may include the GPS receiver 130 and may receive the one or more signals from satellites of the GPS. According to some example embodiments, the positioning system 230 may include another GPS receiver 130 on an attached implement, and may also (or alternatively) receive the one or more signals via the other GPS receiver 130, but some example embodiments are not limited thereto. According to some example embodiments, the positioning system 230 may provide the current position of the vehicle 100 (e.g., the current position of the GPS receiver 130) to the processor 210 and/or the memory 220 at a periodic interval that may be predefined (or alternatively, given). According to some example embodiments, the current position may include geographical coordinate points, such as current x and y coordinates of the vehicle 100 (e.g., Easting and Northing, respectfully), but some example embodiments are not limited thereto. According to some example embodiments, the current position may also include one or more of a time corresponding to the current position of the vehicle 100, a heading of the vehicle 100, a velocity of the vehicle 100 and/or a yaw rate of the vehicle 100 etc. According to some example embodiments, the positioning system 230 may be implemented using processing circuitry. The receiver of the positioning system 230 is mainly referred to herein as being the GPS receiver 130, but some example embodiments are not limited to, and any receiver of a navigation system (e.g., a satellite navigation system) may be used. The receiver may be referred to herein as the GPS receiver 130 for conciseness of description and references thereto do not limit the receiver of the positioning system 230 to only GPS-based implementations.

The mechanical control system 240 may include one or more mechanical systems for controlling a movement and/or position of the vehicle 100. The mechanical control system 240 may include, for example, a steering actuator, a pedal actuator, and implement actuator, etc. (e.g., the steering, pedal and implement actuators 120). Each of the steering actuator, the pedal actuator and the implement actuator may be controlled may perform operations of the vehicle 100 according to corresponding commands received from the processor 210. According to some example embodiments, the mechanical control system 240 may be implemented using processing circuitry. According to some example embodiments, the steering actuator may mechanically move a support structure (e.g., wheels, tracks, etc.) of the vehicle 100 in either direction (e.g., left or right from the forward perspective of the vehicle 100) in an amount corresponding to an updated steering angle included in a command from the processor 210. According to some example embodiments, the pedal actuator may mechanically move the acceleration pedal of the vehicle 100 in either direction (e.g., in or out) in an amount corresponding to a speed adjustment value included in a command from the processor 210. According to some example embodiments, the implement actuator may mechanically move an implement attached to the vehicle 100 to perform a corresponding operation (e.g., an agricultural and/or industrial operation, such as tilling, planting, spraying, harvesting, etc.) based on one or more commands from the processor 210.

According to some example embodiments, the steering actuator may mechanically move a support structure (e.g., wheels, tracks, etc.) of the vehicle 100 in either direction (e.g., left or right from the forward perspective of the vehicle 100, such as the first direction D1) in an amount corresponding to an updated steering angle included in a command from the processor 210. For example, the mechanical control system 240 may include a steering system, such as a hydraulic steering system, an electro-hydraulic steering system, an electromechanical steering system, an electromechanical actuator, an electrical steering system, a drive-by-wire steering system or another steering system with an electrical or electronic control interface for communicating with the processor 210. In some example embodiments, the electronic control interface may include a sensor for detecting a position of a hydraulic cylinder of the steering system, and the steering actuator for controlling the position of the hydraulic cylinder or other member of the steering system, in response to commands from the processor 210. Although the steering system may use digital messages (e.g., logic level signals) to control steering, in some example embodiments the steering system may use analog signals, particularly if the steering system is configured to directly communicate with the processor 210.

According to some example embodiments, the pedal actuator may mechanically move the acceleration pedal and/or the brake pedal of the vehicle 100 in either direction (e.g., in or out) in an amount corresponding to a speed adjustment value included in a command from the processor 210. For example, the mechanical control system 240 may include a braking system, such as a hydraulic braking system, an electro-hydraulic braking system, an electromechanical braking system, an electromechanical actuator, an electrical braking system, a brake-by-wire braking system or another braking system with an electrical or electronic control interface for communicating with the processor 210. In some example embodiments, the electronic control interface may include a sensor for detecting a position of a hydraulic cylinder of the braking system, and the pedal actuator for controlling or modulating the position of the hydraulic cylinder or other member of the braking system, in response to commands from the processor 210. Although the braking system may use digital messages (e.g., logic level signals) to control braking, in some example embodiments the braking system may use analog signals, particularly if the braking system is configured to directly communicate with the processor 210.

The mechanical control system 240 may include a propulsion system having an engine controller and a motive system (e.g., an internal combustion engine, an electric motor, etc.). The engine controller may control a throttle setting, carburetor, fuel injection system, fuel-metering system or air-metering system, or other fuel delivery system for the internal combustion engine, for example. The propulsion system may include an electric motor, a drive motor, an alternating current motor, an induction motor, a permanent magnet motor, a direct current motor, or another suitable motor for propelling a vehicle. Further, the propulsion system may include a motor controller (e.g., an inverter, chopper, wave generator, variable frequency oscillator, variable current Supply, or variable Voltage Supply) for controlling the Velocity, torque, and direction of rotation of the motor shaft of the electric motor. In some example embodiments, the propulsion system may include a hybrid drive system, a parallel hybrid, system, or a series hybrid system, in which at least one of an electric motor and an internal combustion engine can propel the vehicle. For example, in a parallel hybrid system, the electric motor, the internal combustion engine or both may apply power to one or more support structures (e.g. wheels or tracks) of the vehicle 100. For a series hybrid system, the electric motor typically provides power to one or more support structures (wheels or tracks) of the vehicle 100. The engine controller may control the motive system in response to commands from the processor 210.

According to some example embodiments, the implement actuator may mechanically move an implement attached to the vehicle 100 to perform a corresponding operation (e.g., tilling, planting, spraying, harvesting, etc.) based on one or more commands from the processor 210. For example, the mechanical control system 240 may include an implement system, such as a hydraulic implement system, an electro-hydraulic implement system, an electromechanical implement system, an electromechanical actuator, an electrical implement system, a drive-by-wire implement system or another implement system with an electrical or electronic control interface for communicating with the processor 210. In some example embodiments, the electronic control interface may include a sensor for detecting a position of a hydraulic cylinder of the implement system, and the implement actuator for controlling the position of the hydraulic cylinder or other member of the implement system, in response to commands from the processor 210. Although the implement system may use digital messages (e.g., logic level signals) to control the implement, in some example embodiments the implement system may use analog signals, particularly if the implement system is configured to directly communicate with the processor 210.

The UI 250 (e.g., the on-board user interface 112) may include one or more devices for communicating information to, and/or receiving information from, an operator of the vehicle 100. The UI 250 may include a touch screen display, but is not limited thereto and may include any device, or combination of devices, for inputting and outputting information. Information displayed on the UI 250 may be received from the processor 210, and information input to the UI 250 may be provided to the processor 210 and/or the memory 220.

The communication system 260 may include a transmitter, a receiver and/or a transceiver. The communication system 260 may communicate with one or more external devices (e.g., an external server 280, a cloud system, a base station, an access point, etc.) via any wired and/or wireless communication method that would be known to a person having ordinary skill in the art. The communication system 260 may be implemented using processing circuitry. The communication system 260 may communicate signals and/or messages between the processor 210 and the one or more external devices as discussed further below.

The TCU 270 (may also be referred to as a transmission controller) may control a transmission 272 of the vehicle 100. For example, the TCU 270 may control a gear (e.g., a currently selected and/or active gear) (may also be referred to as a gear ratio) of the transmission 272 during operation of the vehicle 100. The transmission 272 may include one or more forward gears and a reverse gear. The TCU 270 may also provide transmission information to the processor 210 and/or memory 220 continuously, periodically and/or in response to a change in the gear of the transmission. The transmission information may include an indication of a currently selected and/or active gear of the transmission 272. According to some example embodiments, the TCU 270 may provide the transmission information to the processor 210 and/or memory 220 via at least one bus 274, for example, a Controller Area Network (CAN) bus (e.g., configured according to the CAN ISOBUS Standard, International Organization for Standardization (ISO) 11783, SAE J1939, etc.), but some example embodiments are not limited thereto. The at least one bus 274 may include two separate buses 274 (as depicted in FIG. 2), but some example embodiments are not limited thereto and the separate buses may be combined into a single bus 274 connecting all of the components of the system 200. The TCU 270 may be implemented using processing circuitry. According to some example embodiments, the transmission 272 and/or the at least one bus 274 may be components of the system 200, but some example embodiments are not limited thereto.

According to some example embodiments, the processor 210 may control the vehicle 100 to perform an operation (e.g., an agricultural and/or industrial operation) in an operational area (e.g., a field, orchard, vineyard, etc.). For example, the processor 210 may control the vehicle 100 (and/or an implement attached to the vehicle 100) to perform an operation, such as tilling, planting, spraying, harvesting, etc., but some example embodiments are not limited thereto.

According to some example embodiments, the processor 210 may collect geographical coordinate points (also referred to herein as coordinate points) while traveling through the operational area (e.g., during performance of the operation). For example, the processor 210 may receive the geographical coordinate points from the positioning system 230. According to some example embodiments, each of the collected geographical coordinate points (may also be referred to herein as coordinate points or collected coordinate points) may include current x and y coordinates of the vehicle 100 (e.g., Easting and Northing, respectfully), but some example embodiments are not limited thereto. According to some example embodiments, each of the collected geographical coordinate points may also include one or more of a time corresponding to the current position of the vehicle 100, a heading of the vehicle 100, a velocity of the vehicle 100 and/or a yaw rate of the vehicle 100 etc. The processor 210 may store the collected coordinate points (e.g., in the memory 220). According to some example embodiments, the processor 210 may generate a navigational path (also referred to herein as a path) corresponding to the operation by connecting consecutively collected coordinate points with line segments. The processor 210 may store the generated path (e.g., in the memory 220).

According to some example embodiments, the processor 210 may determine whether one or more of the collected coordinate points, and/or a path generated therefrom, represents a vestigial coordinate point(s) (and/or path(s)). For example, the processor 210 may determine that coordinate points, and/or paths generated therefrom, that correspond to a period of time in which the vehicle 100 is traveling in reverse, backing up to adjust a forward trajectory of the vehicle 100, traveling between operational sub-areas (e.g., sub-fields) of the operational area, turning around a corner, and/or recovering from an operation stoppage represent vestigial coordinate point(s) (and/or path(s)).

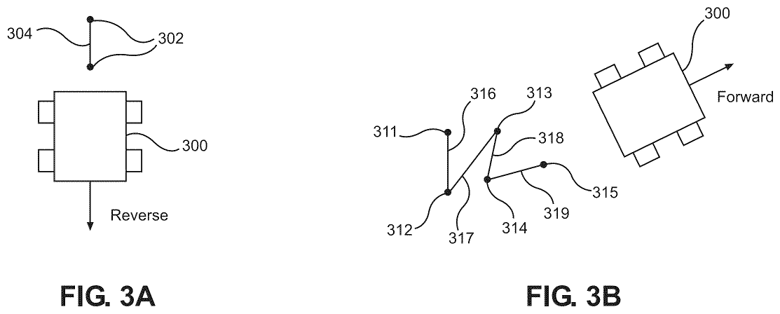

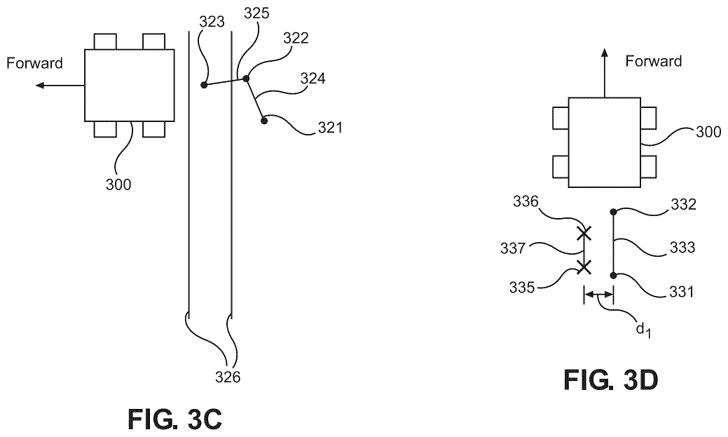

FIGS. 3A-3D illustrate conditions in which vestigial coordinate points and paths are generated, according to some example embodiments.

Referring to FIGS. 2 and 3A, according to some example embodiments, the processor 210 may determine whether geographical coordinate point(s) collected, and/or path(s) generated therefrom, satisfy a first condition. The first condition may be representative of the vehicle 100 traveling in a reverse direction. The processor 210 may determine that a transmission 272 of the vehicle 100 is configured to permit travel in a reverse direction (e.g., a direction opposite from the first direction D1) based on a corresponding indicator received from the transmission 272 (and/or a controller of the transmission). For example, the processor 210 may receive the transmission information from the TCU 270, and may use the indication of a currently selected and/or active gear of the transmission 272 to determine whether the vehicle 100 is configured to travel in the reverse direction, thereby satisfying the first condition. The processor 210 may determine that coordinate point(s) collected while the first condition is satisfied (e.g., while the vehicle 100 is configured to travel in the reverse direction), and/or path(s) generated therefrom, represent vestigial coordinate point(s) (and/or path(s)).

For example, referring to FIG. 3A, a vehicle 300 is depicted as traveling in the reverse direction. Coordinate points 302 collected while the vehicle 300 was traveling in the reverse direction, as well as a path 304 connecting the coordinate points 302, may be determined by the processor 210 to satisfy the first condition, and thus, may be determined by the processor 210 to represent vestigial coordinate points and a vestigial path, respectively. According to some example embodiments, the vehicle 300 may be implemented by the vehicle 100 and may incorporate the system 200.

Referring to FIGS. 2 and 3B, according to some example embodiments, the processor 210 may determine whether geographical coordinate points collected, and/or paths generated therefrom, satisfy a second condition. The second condition may be representative of the vehicle 100 backing up to adjust a forward trajectory of the vehicle 100. For example, the vehicle 100 may be controlled to perform such a maneuver to navigate tight headlands of the operational area, etc. The processor 210 may determine that the second condition is satisfied by detecting whether the vehicle has performed a quantity of sequential short forward and reverse maneuvers (e.g., sequentially traveling in forward and reverse directions) greater than or equal to a first threshold. The processor 210 may determine whether a maneuver occurs in a forward or reverse direction based on the indication of the currently selected and/or active gear of the transmission 272 (e.g., a forward gear, neutral/no selected or active gear, a reverse gear, etc.) provided by the TCU 270, as discussed further above. According to some example embodiments, the short forward and reverse maneuvers may involve traveling a distance less than or equal to a second threshold. According to some example embodiments, the first threshold and/or second threshold may be a design parameter(s) determined through empirical study, but some example embodiments are not limited thereto. According to some example embodiments, the first threshold and/or second threshold may be input by an operator of the vehicle 100 (e.g., via the UI 250). According to some example embodiments, the processor 210 may determine that the second condition is satisfied with respect to coordinate points collected while the vehicle 100 performs a quantity of sequential forward and reverse maneuvers that is greater than or equal to the first threshold, each of the maneuvers involving traveling a distance less than or equal to the second threshold. The processor 210 may determine that collected coordinate points that satisfy the second condition, and/or paths generated therefrom, represent vestigial coordinate points (and/or paths).

For example, referring to FIG. 3B, the vehicle 300 is depicted as traveling in the forward direction after performing several short forward and reverse maneuvers. For example, the vehicle 300 is depicted as performing a first reverse maneuver from a first coordinate point 311 to a second coordinate point 312, a first forward maneuver from the second coordinate point 312 to a third coordinate point 313, a second reverse maneuver from the third coordinate point 313 to a fourth coordinate point 314, and a second forward maneuver from the fourth coordinate point 314 to a fifth coordinate point 315. While the coordinate points 311 to 315 are illustrated as being at the start and end points of these forward/reverse maneuvers, this example is for clarity of description and some example embodiments are not limited thereto. The processor 210 may collect the coordinate points 311 to 315 while the vehicle 300 performs the above-described forward/reverse maneuvers

As may be appreciated from the above discussion, coordinate point(s) collected, and/or path(s) generated therefrom, during the first reverse maneuver and the second reverse maneuver may be determined by the processor 210 as satisfying the first condition, and thus, as representing vestigial coordinate point(s) (and/or path(s)). Also, according to some example embodiments, each of the first reverse maneuver, the first forward maneuver and the second reverse maneuver may involve traveling a distance less than the second threshold, and the first threshold may be equal to three. Accordingly, the processor 210 may determine that the coordinate points 311 to 315, as well as paths 316, 317, 318 and 319 connecting the coordinate points 311 to 315 (including the coordinate points and path corresponding to the first forward maneuver), satisfy the second condition, and thus, represent vestigial coordinate points and vestigial paths, respectively. As noted above, in the example illustrated in FIG. 3B, the first threshold may be equal to three, but this is merely an example and some example embodiments are not limited thereto. For example, the first threshold may be input by an operator of the vehicle 100, and/or may be a design parameter determined through empirical study, as indicated above.

Referring to FIGS. 2 and 3C, according to some example embodiments, the processor 210 may determine whether geographical coordinate point(s) collected, and/or path(s) generated therefrom, satisfy a third condition. The third condition may be representative of the vehicle 100 traveling between operational sub-areas and/or turning around a corner. The vehicle 100 may determine that the third condition is satisfied based on the vehicle 100 performing a short maneuver that crosses (or follows a trajectory that would cross) an adjacent path. For example, paths may have been previously generated for use by the vehicle 100 in performing a current operation (e.g., an agricultural and/or industrial operation). The processor 210 may determine whether the short maneuver deviates (in a lateral direction) from a direction of one or more of these previously generated paths by an amount greater than or equal to a third threshold. For example, in a scenario in which North is the direction of one or more of the previously generated paths, East and/or West may represent the lateral direction (which may be perpendicular to the direction of one or more of the previously generated paths). According to some example embodiments, the processor 210 may determine the direction of the previously generated paths as an average direction of a plurality of the previously generated paths, but some example embodiments are not limited thereto. According to some example embodiments, the processor 210 may determine that the maneuver is a short maneuver based on a distance in which the vehicle 100 travels during the maneuver being less than or equal to a fourth threshold.

According to some example embodiments, the third threshold and/or fourth threshold may be a design parameter(s) determined through empirical study, but some example embodiments are not limited thereto. According to some example embodiments, the third threshold and/or fourth threshold may be input by an operator of the vehicle 100 (e.g., via the UI 250). According to some example embodiments, the third threshold may be a distance that is 10% of a track spacing (e.g., the distance between two adjacent paths among the previously generated paths), but some example embodiments are not limited thereto. According to some example embodiments, the fourth threshold may be a distance that is 5% of a headline distance (or 5% of a length, or average length, of the previously generated paths), but some example embodiments are not limited thereto.

According to some example embodiments, the processor 210 may determine that the third condition is satisfied with respect to coordinate point(s) collected while the vehicle 100 performs a maneuver that deviates from a direction of one or more of these previously generated paths by an amount greater than or equal to a third threshold, the maneuver involving traveling a distance less than or equal to the fourth threshold. The processor 210 may determine that collected coordinate point(s) that satisfy the third condition, and/or path(s) generated therefrom, represent vestigial coordinate point(s) (and/or path(s)). According to some example embodiments, the traveling distance of the maneuver corresponds to a distance traveled while the direction of the vehicle 100 is changing (e.g., deviating) relative to the direction of the previously generated path(s) (e.g., is not measured while the direction of travel is within a threshold margin of error of the direction of the previously generated path(s)).

For example, referring to FIG. 3C, the vehicle 300 is depicted as performing a maneuver. During the maneuver, coordinate points 321, 322 and 323 are collected. While the coordinate points 321 and 323 are illustrated as being at the start and end points of the maneuver, this example is for clarity of description and some example embodiments are not limited thereto. According to some example embodiments, the traveling distance of the maneuver is less than the fourth threshold, and the amount of deviation from previously generated paths 326 is greater than the third threshold. Accordingly, the processor 210 may determine that the coordinate points 321 to 323, as well as paths 324 and 325 connecting the coordinate points 321 to 323, satisfy the third condition, and thus, represent vestigial coordinate points and vestigial paths, respectively.

Referring to FIGS. 2 and 3D, according to some example embodiments, the processor 210 may determine whether geographical coordinate point(s) collected, and/or path(s) generated therefrom, satisfy a fourth condition. The fourth condition may be representative of the vehicle 100 recovering from an operation stoppage. Operation stoppages may be caused by, for example, exhaustion of fuel for the vehicle 100, blockage in a component of the vehicle 100 (e.g., a seeder, etc.), exhaustion of another resource of the vehicle 100 (e.g., a spraying liquid, etc.), etc. Operation stoppages may result in the vehicle 100 traveling (e.g., traveling forward) in the operational area without performing the operation, and resuming the operation by traveling back to a position at which the operation stoppage occurred. For example, to recover from an operation stoppage, the vehicle 100 may (1) reverse from a position at which the operation stoppage is detected (e.g., by an operator of the vehicle 100) (also referred to herein as a first position) to the position at which the operation stoppage occurred (also referred to herein a second position), and (2) advance back to the first position from the second position while performing the operation. As may be appreciated from the above discussion, coordinate point(s) collected, and/or path(s) generated therefrom, while reversing from the first position to the second position may be determined by the processor 210 as satisfying the first condition, and thus, as representing vestigial coordinate point(s) (and/or path(s)).

Also, the processor 210 may determine whether coordinate point(s) collected, and/or path(s) generated therefrom, correspond to the vehicle 100 advancing back to the first position from the second position (e.g., satisfy the fourth condition). For example, the processor 210 may determine whether coordinate point(s) collected while the vehicle 100 travels in the forward direction, and/or path(s) generated therefrom, (also referred to herein as currently collected points/paths) overlap previously collected coordinate point(s) (and/or path(s)). The processor 210 may determine whether the vehicle 100 is traveling in the forward direction based on the indication of the currently selected and/or active gear of the transmission 272 (e.g., a forward gear, neutral, a reverse gear, etc.) provided by the TCU 270, as discussed further above. The processor 210 may determine whether currently collected coordinate point(s), and/or path(s) generated therefrom, overlap previously collected coordinate point(s) (and/or path(s)) (hereinafter referred to as previously collected points/paths) by comparing the currently collected points/paths to previously collected points/paths stored in the memory 220.

According to some example embodiments, the processor 210 may determine that a currently collected point/path overlaps a previously collected point/path based on a lateral distance (e.g., a distance in a lateral direction) between the currently collected point/path and a first line on which the previously collected point/path fall being less than or equal to a fifth threshold. According to some example embodiments, the first line may be represented by (e.g., may be) the previously collected path, or a path including the previously collected point. For example, according to some example embodiments, in a scenario in which the first line falls along the North-South axis, and East or West may represent the lateral direction (which may be perpendicular to the first line). The fifth threshold may represent a margin of error with respect to the degree of overlap between the currently and previously collected points/paths. According to some example embodiments, the fifth threshold may be a design parameter determined through empirical study, but some example embodiments are not limited thereto. According to some example embodiments, the fifth threshold may be input by an operator of the vehicle 100 (e.g., via the UI 250).

According to some example embodiments, the processor 210 may determine that the fourth condition is satisfied with respect to coordinate point(s) collected (e.g., while the vehicle 100 travels in the forward direction), and/or paths generated therefrom, based on the collected coordinate point(s) being a lateral distance from previously collected coordinate point(s)/path(s) less than or equal to the fifth threshold. The processor 210 may determine that collected coordinate point(s) that satisfy the fourth condition, and/or path(s) generated therefrom, represent vestigial coordinate point(s) (and/or path(s)).

For example, referring to FIG. 3D, the vehicle 300 is depicted as traveling in the forward direction. A first current coordinate point 331 and a second current coordinate point 332 may represent currently collected points. A first previous coordinate point 335 and a second previous coordinate point 336 may represent previously collected points. A previous path 337 connecting the first previous coordinate point 335 and the second previous coordinate point 336 may represent the first line on which the previously collected points/path fall. The first current coordinate point 331 and the second current coordinate point 332, as well as a current path 333 connecting the first current coordinate point 331 and the second current coordinate point 332, are separated from the first line by a lateral distance d1.

According to some example embodiments, the lateral distance d1 may be less than the fifth threshold. Accordingly, the processor 210 may determine that the first current coordinate point 331 and the second current coordinate point 332, as well as the current path 333 connecting the first current coordinate point 331 and the second current coordinate point 332, satisfy the fourth condition, and thus, represent vestigial coordinate points and a vestigial path, respectively.

Referring to FIG. 2, according to some example embodiments, the processor 210 may automatically delete the geographical coordinate point(s) determined to represent vestigial coordinate point(s) (and/or path(s)), but some example embodiments are not limited thereto. According to some example embodiments, the processor 210 may associate the coordinate point(s) determined to represent vestigial coordinate point(s) (and/or path(s)) with an indication (also referred to herein as a vestigial indication) identifying the coordinate point(s) as having been determined to be vestigial, without deleting the coordinate point(s). According to some example embodiments, the vestigial indication may be stored (e.g., in the memory 220) in association with the coordinate point(s) determined to represent vestigial coordinate point(s) (and/or path(s)).

According to some example embodiments, the vestigial indication may be displayed (e.g., by the UI 250) in association with the coordinate point(s) determined to represent vestigial coordinate point(s) (and/or path(s)). According to some example embodiments, the vestigial indication may be represented on the UI 250 as a highlighting (and/or bolding, color coding, etc.) of the coordinate point(s) (and/or path(s)) determined by the processor 210 to be vestigial, but some example embodiments are not limited thereto. According to some example embodiments, each of the coordinate point(s) determined to represent vestigial coordinate point(s) (and/or path(s)) may be displayed in association with a corresponding unique identifier (e.g., a track number). According to some example embodiments, the coordinate point(s) determined to represent vestigial coordinate point(s) (and/or path(s)) may be displayed on a map of the operational area along with the vestigial indication.

According to some example embodiments, the UI 250 may receive an input (e.g., from an operator of the vehicle 100) to delete (e.g., representing a selection to delete) one or more of the geographical coordinate point(s) (and/or path(s)) associated with the vestigial indication. For example, the input may indicate to delete one or more highlighted coordinate point(s) (and/or path(s)), specify an identifier associated with one or more coordinate point(s) (and/or path(s)), include selection of a checkbox associated with one or more coordinate point(s) (and/or path(s)), etc. According to some example embodiments, the processor 210 may delete the one or more of the coordinate point(s) (and/or path(s)) identified in the input as being selected for deletion. According to some example embodiments, the processor 210 may cause the one or more of the coordinate point(s) (and/or path(s)) associated with the vestigial indication to be displayed on the UI 250, and may receive the input to delete the one or more of the coordinate point(s) during the performance of the operation in the operational area (e.g., in real-time), but some example embodiments are not limited thereto. According to some example embodiments, the processor 210 may only cause the one or more of the coordinate point(s) (and/or path(s)) associated with the vestigial indication to be displayed on the UI 250, and receive the input to delete the one or more of the coordinate point(s) (and/or path(s)), after completion of the performance of the operation in the operational area. According to some example embodiments, coordinate point(s) (and/or path(s)) displayed on the UI 250 without being selected for deletion may be stored (e.g., in the memory 220) and used for generation (or updating) of a path. According to some example embodiments, references to deletion of coordinate point(s) (and/or path(s)) herein may refer to removal of the coordinate point(s) (and/or path(s)) from among a set including a plurality of coordinate points and/or paths, to thereby obtain a new subset. The new subset may be used to generate a new path or update a previous path.

According to some example embodiments, in addition (or alternatively) to displaying (e.g., by the UI 250) the geographical coordinate point(s) determined to represent vestigial coordinate point(s) (and/or path(s)), the processor 210 may transfer the coordinate point(s) determined to represent vestigial coordinate point(s) (and/or path(s)) (e.g., along with the corresponding vestigial indication) to the external server 280 (e.g., via the communication system 260). According to some example embodiments, the processor 210 may also transfer coordinate point(s) not determined to represent vestigial coordinate point(s) (and/or path(s)) to the external server 280 (e.g., via the communication system 260). According to some example embodiments, the external server 280 may delete (e.g., automatically, or manually through selection by an operator) one or more of the coordinate point(s) determined to represent vestigial coordinate point(s) (and/or path(s)).

According to some example embodiments, the processor 210 may associate a confidence level with the determination of the geographical coordinate point(s) as representing vestigial coordinate point(s) (and/or path(s)). For example, the processor 210 may associate coordinate point(s) satisfying the first condition or the fourth condition as being of a higher confidence level than coordinate points satisfying the second condition or the third condition. According to some example embodiments, the processor 210 may automatically delete coordinate points satisfying the first condition or the fourth condition (e.g., associated with the higher confidence level) without displaying these coordinate points on the UI 250 (or transferring the coordinate points to the external server 280) for review by the operator of the vehicle 100. According to some example embodiments, the processor 210 may only display coordinate points on the UI 250 (or transfer the coordinate points to the external server 280) that satisfy the second condition or the third condition (e.g., associated with a lower confidence level).

According to some example embodiments, the processor 210 may generate a new path, or update a previous path, based on geographical coordinate point(s) (and/or path(s)) stored in the memory 220 (e.g., that were not deleted/removed based on a determination that the point(s)/path(s) were vestigial), but some example embodiments are not limited thereto. Geographical coordinate points that remain after vestigial points have been deleted/removed may be referred to herein as non-vestigial coordinate points (and/or paths). According to some example embodiments, the new path may be generated, or the previous path updated, by the external server 280 based on the non-vestigial coordinate point(s) (and/or path(s)). In such examples, the new/updated path may be transferred (e.g., via the communication system 260) to the vehicle 100 by the external server 280 (e.g., for storage in the memory 220).

According to some example embodiments, the new path may be generated, or the previous path updated, using any process and/or algorithm that would be known to a person having ordinary skill in the art. Such a path generation and/or updating algorithm may be stored in the memory 220 (and/or the external server 280) and executed by the processor 210 (and/or the external server 280). For instance, according to some example embodiments, the path generation and/or updating algorithm may include pairing respective coordinate points among the non-vestigial coordinate points based on a proximity of the respective coordinate points with respect to geographical distance and/or collection time of the respective coordinate points. The paired coordinate points may be connected with line segments to form the new and/or updated path. According to some example embodiments, a previous path may be updated following deletion/removal of vestigial coordinate points by connecting remaining, non-vestigial coordinates with line segments according to, for example, the above-described algorithm. According to some example embodiments, the processor 210 may cause the vehicle 100 to perform a new operation (e.g., a new agricultural and/or industrial operation) in the operational area by following the new and/or updated path. Examples described herein mainly describe obtaining a new/updated subset of coordinate points (e.g., a plurality of non-vestigial coordinate points) by deleting/removing coordinate points from an existing set of coordinate points in response to determining the coordinate points are vestigial coordinate points and/or a corresponding selection, however some example embodiments are not limited thereto. For example, according to some example embodiments, the new subset (e.g., a plurality of non-vestigial coordinate points) may be generated to include only coordinate points that have not been determined to be vestigial coordinate points and/or not selected.

According to example embodiments, improved devices and methods are provided for navigational path generation. For example, as described herein, the processor 210 may determine and delete vestigial coordinate point(s)/path(s) from among coordinate point(s)/path(s) obtained while performing an operation in an operational area. Accordingly, paths may be generated and/or updated based on the obtained coordinate point(s)/path(s) without the noise represented by the vestigial coordinate point(s)/path(s). Thus, the improved devices and methods overcome the deficiencies of the existing devices to at least improve the accuracy of generated and/or updated paths, thereby providing paths that vehicles may easily follow, and reducing resource consumption (e.g., delay, fuel, vehicle wear, etc.) and/or property damage (e.g., to a crop, the vehicle, other objects in the operational area, etc.) resulting from inaccurate paths.

According to some example embodiments, the processor 210 may cause the vehicle 100 to perform the operation and/or the new operation by following a path stored in the memory 220 (e.g., the new/updated path). According to some example embodiments, the processor 210 may cause the vehicle 100 to follow the new and/or updated path using any process and/or algorithm that would be known to a person having ordinary skill in the art. Such a path following algorithm may be stored in the memory 220 and executed by the processor 210. For instance, according to some example embodiments, during the path following, the processor 210 may determine a first distance between a current position of the vehicle 100 (e.g., a current position of the receiver of the positioning system 230) and the path (also referred to herein as a lateral error). According to some example embodiments, the first distance may be measured as a length of a line (e.g., in the second direction D2) perpendicular to the path (e.g., in the first direction D1) that connects the current position of the vehicle 100 to the path. According to some example embodiments, the processor 210 may obtain an updated steering angle (or steering angle adjustment) based on the first distance. According to some example embodiments, the processor 210 may obtain the updated steering angle (or the steering angle adjustment) by comparing the first distance with a second look-up table (LUT) stored in the memory 220. The second LUT may include different steering angles in association with different first distances. According to some example embodiments, the processor 210 may calculate the updated steering angle (or steering angle adjustment) by inputting the first distance into a first function. The first function may be determined through empirical study, but some example embodiments are not limited thereto. According to some example embodiments, the processor 210 may determine the updated steering angle (or the steering angle adjustment) based on the first distance using a Proportional-Integral-Derivative (PID) algorithm stored in the memory 220.

According to some example embodiments, the first distance may indicate a side of the vehicle 100 on which the path is positioned (and in which the first distance is measured/calculated), for example, lateral error on the left side of the path may be indicated with a negative first distance value and lateral error on the right side of the path may be indicated with positive first distance value. However, some example embodiments are not limited thereto, and a separate indication may be provided (e.g., by the processor 210) to indicate the side of the path on which the control guide point is positioned.

The processor 210 may provide a command to the steering actuator (e.g., among the steering, pedal and implement actuators 120 of the mechanical control system 240) corresponding to the updated steering angle (or steering angle adjustment). In so doing, the processor 210 may control/cause the steering actuator to mechanically move a support structure (e.g., wheels, tracks, etc.) of the vehicle 100 based on (e.g., to affect) the updated steering angle. For example, the processor 210 may control/cause the steering actuator to extend and/or retract, thereby mechanically move a support structure (e.g., wheels, tracks, etc.) of the vehicle 100 towards a left or right direction (from the perspective of the vehicle 100) consistent with the updated steering angle. Thereby the processor 210 may minimize or reduce the lateral error.

According to some example embodiments, the determination of the lateral error may be performed continuously or repeatedly (e.g., periodically) while the vehicle 100 performs the operation (e.g., the agricultural and/or industrial operation). According to some example embodiments, the operation (and/or the new operation) performed by the vehicle 100 may involve the use of an attached implement. In such a scenario, the processor 210 may provide one or more commands to the implement actuator (e.g., among the steering, pedal and implement actuators 120 of the mechanical control system 240) based on an algorithm (or other computer-readable instructions) corresponding to the operation and stored in the memory 220. In so doing, the processor 210 may control/cause the implement actuator to mechanically move the implement attached to the vehicle 100 based on (e.g., to affect) the algorithm (or other computer-readable instructions). For example, the processor 210 may control/cause the steering actuator to extend and/or retract, thereby mechanically extending and/or retracting the implement attached to the vehicle 100 consistent with the algorithm (or other computer-readable instructions).

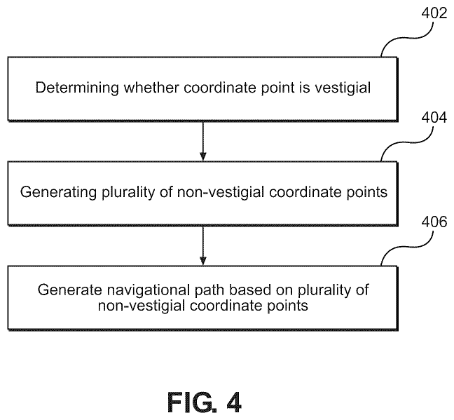

FIG. 4 illustrates a method for removing vestigial coordinate points and paths, according to some example embodiments. According to some example embodiments, the method may be performed by the processor 210.

Referring to FIG. 4, in operation 402, the method may include determining whether a collected coordinate point is a vestigial coordinate point. For example, the processor 210 may determine whether a first coordinate point is a vestigial coordinate point, the first coordinate point being among a plurality of coordinate points, each coordinate point among the plurality of coordinate points representing a corresponding geographical position of a vehicle. According to some example embodiments, the first coordinate point corresponds to a first maneuver performed by the vehicle. According to some example embodiments, the processor 210 may determine whether a first coordinate point is a vestigial coordinate point based on at least one of a first travel direction of the first maneuver, a first travel distance of the first maneuver, or a first lateral distance of the first maneuver from a previous navigational path.

According to some example embodiments, the processor 210 may determine whether a first coordinate point is a vestigial coordinate point based on the first travel direction being a reverse direction (e.g., based on a travel direction of the first maneuver being a reverse direction).

According to some example embodiments, the processor 210 may determine whether a first coordinate point is a vestigial coordinate point based on the first maneuver being among a sequence of maneuvers, a travel direction of the sequence of maneuvers alternating between a forward direction and a reverse direction, a quantity of maneuvers among the sequence of maneuvers being greater than or equal to a first threshold, and a travel distance of each among the sequence of maneuvers being less than or equal to a second threshold.

According to some example embodiments, the processor 210 may determine whether a first coordinate point is a vestigial coordinate point based on the first lateral distance being greater than or equal to a first threshold (e.g., based on a lateral distance of the first maneuver from a previous navigational path being greater than or equal to a first threshold), and the first travel distance being less than or equal to a second threshold (e.g., based on a travel distance of the first maneuver being less than or equal to a second threshold).

According to some example embodiments, the processor 210 may determine whether a first coordinate point is a vestigial coordinate point based on the first lateral distance being less than or equal to a first threshold (e.g., based on a lateral distance of the first maneuver from a previous navigational path being less than or equal to a first threshold).

In operation 404, the method may include generating a set of non-vestigial coordinate points based on the plurality of coordinate points in response to determining the first coordinate point is the vestigial coordinate point, the first coordinate point not being included among the plurality of non-vestigial coordinate points. For example, the processor 210 may remove the first coordinate point from among the plurality of coordinate points in response to determining the first coordinate point is the vestigial coordinate point to obtain a plurality of non-vestigial coordinate points.

In operation 406, the method may include generating a navigational path based on a subset of non-vestigial coordinate points. For example, the processor 210 may generate a first navigational path based on the plurality of non-vestigial coordinate points. According to some example embodiments, the method may further include controlling the vehicle to follow the first navigational path including determining a lateral error between a current geographical position of the vehicle and the first navigational path, and controlling a steering actuator of the vehicle to adjust a steering angle based on the lateral error, as discussed further above.

According to some example embodiments, the above-described method (e.g., operation 404) may be repeated periodically or continuously throughout an operation of the vehicle 100, but some example embodiments are not limited thereto.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with some example embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 220).

According to some example embodiments, the memory 220 may each be a tangible, non-transitory computer-readable medium, such as a Random Access Memory (RAM), a flash memory, a Read Only Memory (ROM), an Electrically Programmable ROM (EPROM), an Electrically Erasable Programmable ROM (EEPROM), registers, a hard disk, a removable disk, a Compact Disk (CD) ROM, any combination thereof, or any other form of storage medium known in the art.

Some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

It will be understood that when an element is referred to as being “connected” or “coupled” to another element, it may be directly connected or coupled to the other element or intervening elements may be present. As used herein the term “and/or” includes any and all combinations of one or more of the associated listed items.

Although terms of “first” or “second” may be used to explain various components (or parameters, values, etc.), the components (or parameters, values, etc.) are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

1. A system on a vehicle, the system comprising:
processing circuitry configured to cause the system to
determine whether a first coordinate point is a vestigial coordinate point, the first coordinate point being among a plurality of coordinate points, each coordinate point among the plurality of coordinate points representing a corresponding geographical position of the vehicle,
generate a plurality of non-vestigial coordinate points based on the plurality of coordinate points in response to determining the first coordinate point is the vestigial coordinate point, the first coordinate point not being included among the plurality of non-vestigial coordinate points, and
generate a first navigational path based on the plurality of non-vestigial coordinate points.

2. The system of claim 1, wherein
the first coordinate point corresponds to a first maneuver performed by the vehicle; and
the processing circuitry is configured to cause the system to determine whether the first coordinate point is the vestigial coordinate point based on at least one of,
a first travel direction of the first maneuver,
a first travel distance of the first maneuver, or
a first lateral distance of the first maneuver from a previous navigational path.

3. The system of claim 2, wherein the processing circuitry is configured to cause the system to determine that the first coordinate point is the vestigial coordinate point based on the first travel direction being a reverse direction.

4. The system of claim 2, wherein the processing circuitry is configured to cause the system to determine that the first coordinate point is the vestigial coordinate point based on the first maneuver being among a sequence of maneuvers, a travel direction of the sequence of maneuvers alternating between a forward direction and a reverse direction, a quantity of maneuvers among the sequence of maneuvers being greater than or equal to a first threshold, and a travel distance of each among the sequence of maneuvers being less than or equal to a second threshold.

5. The system of claim 2, wherein the processing circuitry is configured to cause the system to determine that the first coordinate point is the vestigial coordinate point based on:
the first lateral distance being greater than or equal to a first threshold; and
the first travel distance being less than or equal to a second threshold.

6. The system of claim 2, wherein the processing circuitry is configured to cause the system to determine that the first coordinate point is the vestigial coordinate point based on the first lateral distance being less than or equal to a first threshold.

7. The system of claim 1, wherein the processing circuitry is configured to cause the system to control the vehicle to follow the first navigational path including:
determining a lateral error between a current geographical position of the vehicle and the first navigational path; and
controlling a steering actuator of the vehicle to adjust a steering angle based on the lateral error.

8. A method, comprising:
determining whether a first coordinate point is a vestigial coordinate point, the first coordinate point being among a plurality of coordinate points, each coordinate point among the plurality of coordinate points representing a corresponding geographical position of a vehicle;
generating a plurality of non-vestigial coordinate points based on the plurality of coordinate points in response to determining the first coordinate point is the vestigial coordinate point, the first coordinate point not being included among the plurality of non-vestigial coordinate points; and
generating a first navigational path based on the plurality of non-vestigial coordinate points.

9. The method of claim 8, wherein
the first coordinate point corresponds to a first maneuver performed by the vehicle; and
the determining comprises determining whether the first coordinate point is the vestigial coordinate point based on at least one of,
a first travel direction of the first maneuver,
a first travel distance of the first maneuver, or
a first lateral distance of the first maneuver from a previous navigational path.

10. The method of claim 9, wherein the determining comprises determining that the first coordinate point is the vestigial coordinate point based on the first travel direction being a reverse direction.

11. The method of claim 9, wherein the determining comprises determining that the first coordinate point is the vestigial coordinate point based on the first maneuver being among a sequence of maneuvers, a travel direction of the sequence of maneuvers alternating between a forward direction and a reverse direction, a quantity of maneuvers among the sequence of maneuvers being greater than or equal to a first threshold, and a travel distance of each among the sequence of maneuvers being less than or equal to a second threshold.

12. The method of claim 9, wherein the determining comprises determining that the first coordinate point is the vestigial coordinate point based on:
the first lateral distance being greater than or equal to a first threshold; and
the first travel distance being less than or equal to a second threshold.

13. The method of claim 9, wherein the determining comprises determining that the first coordinate point is the vestigial coordinate point based on the first lateral distance being less than or equal to a first threshold.

14. The method of claim 8, further comprising:
controlling the vehicle to follow the first navigational path including
determining a lateral error between a current geographical position of the vehicle and the first navigational path, and
controlling a steering actuator of the vehicle to adjust a steering angle based on the lateral error.

15. A non-transitory computer-readable medium storing instructions that, when executed by at least one processor, cause the at least one processor to perform a method, the method comprising:
determining whether a first coordinate point is a vestigial coordinate point, the first coordinate point being among a plurality of coordinate points, each coordinate point among the plurality of coordinate points representing a corresponding geographical position of a vehicle;
generating a plurality of non-vestigial coordinate points based on the plurality of coordinate points in response to determining the first coordinate point is the vestigial coordinate point, the first coordinate point not being included among the plurality of non-vestigial coordinate points; and
generating a first navigational path based on the plurality of non-vestigial coordinate points.

16. The non-transitory computer-readable medium of claim 15, wherein
the first coordinate point corresponds to a first maneuver performed by the vehicle; and
the determining comprises determining that the first coordinate point is the vestigial coordinate point based on a travel direction of the first maneuver being a reverse direction.

17. The non-transitory computer-readable medium of claim 15, wherein
the first coordinate point corresponds to a first maneuver performed by the vehicle; and
the determining comprises determining that the first coordinate point is the vestigial coordinate point based on the first maneuver being among a sequence of maneuvers, a travel direction of the sequence of maneuvers alternating between a forward direction and a reverse direction, a quantity of maneuvers among the sequence of maneuvers being greater than or equal to a first threshold, and a travel distance of each among the sequence of maneuvers being less than or equal to a second threshold.

18. The non-transitory computer-readable medium of claim 15, wherein
the first coordinate point corresponds to a first maneuver performed by the vehicle; and
the determining comprises determining that the first coordinate point is the vestigial coordinate point based on
a lateral distance of the first maneuver from a previous navigational path being greater than or equal to a first threshold; and
a travel distance of the first maneuver being less than or equal to a second threshold.

19. The non-transitory computer-readable medium of claim 15, wherein
the first coordinate point corresponds to a first maneuver performed by the vehicle; and
the determining comprises determining that the first coordinate point is the vestigial coordinate point based on a lateral distance of the first maneuver from a previous navigational path being less than or equal to a first threshold.

20. The non-transitory computer-readable medium of claim 15, wherein the method further comprises:
controlling the vehicle to follow the first navigational path including
determining a lateral error between a current geographical position of the vehicle and the first navigational path, and
controlling a steering actuator of the vehicle to adjust a steering angle based on the lateral error.
